(19) United States
(12) Patent Application Publication
(10) Pub. No.: US 2023/0173556 A1
(43) Pub. Date: Jun. 8, 2023

(54) APPARATUS FOR APPLYING AN ADHESIVE LAYER

(71) Applicant: Illinois Tool Works Inc., Glenview, IL (US)

(72) Inventors: Sheila Hamilton, Glasgow (GB); Stephen Frank Mitchell, Glasgow (GB)

(21) Appl. No.: 17/926,194

(22) PCT Filed: May 5, 2021
(86) PCT No.: PCT/US2021/030903

§ 371 Date: Nov. 18, 2022

(30) Foreign Application Priority Data
Jun. 1, 2020 (GB) 2008169.1

(51) Int. Cl. B08B 7/00

(52) U.S. Cl. CPC B08B 7/0028

(57) ABSTRACT

The present disclosure relates to an apparatus for applying an adhesive layer to an adhesive roll in a contact cleaning device, in particular, but not exclusively, to an apparatus including an applicator or an apparatus including a cartridge with an applicator. The present invention also relates to apparatus for contact cleaning a substrate surface including a contact cleaning roller, an adhesive roll and an applicator. The apparatus is suitable for applying an adhesive layer to an adhesive roll in a contact cleaning device, said apparatus comprising an applicator arranged and configured to apply at least one adhesive layer to an outer surface of the adhesive roll.

### RELATED APPLICATIONS

The present application claims the benefit of United Kingdom (GB) Patent Application No. 2008169.1, filed Jun. 1, 2020, entitled “Apparatus for Applying an Adhesive Layer.” The entirety of United Kingdom (GB) Patent Application No. 2008169.1 is expressly incorporated herein by reference.

### FIELD OF THE DISCLOSURE

The present invention relates to an apparatus for applying an adhesive layer to an adhesive roll in a contact cleaning device, in particular, but not exclusively, to an apparatus including an applicator or an apparatus including a cartridge with an applicator. The present invention also relates to apparatus for contact cleaning a substrate surface including a contact cleaning roller, an adhesive roll and an applicator.

### BACKGROUND

Contact cleaning is used to clean substrate surfaces. Once cleaned, the substrate surface may be used in a variety of sophisticated processes such as in the manufacturing of electronics, photovoltaics and flat panel displays. Usually, a rubber or elastomeric cleaning roller is used to remove contaminating particles from a substrate surface and an adhesive roll can then be used to remove the contaminating particles or debris from the cleaning roller. This allows the cleaning roller to maximise its efficiency in removing contaminating particles from the substrate surface.

In contact cleaning, an adhesive roll typically comprises a wound length, or sheeted lengths, of substrate material wrapped around a core. The substrate material includes an adhesive side which can be used to remove or collect the debris from the surface of the cleaning roller.

As the adhesive roller removes debris, the outermost length of the adhesive material will lose effectiveness until performance falls below a required threshold. When the performance falls below the required threshold the adhesive material is spent and must be removed. This may be done by a user cutting away the outer circumference of the used portion of a continuous length of adhesive material, leaving behind a new portion of continuous adhesive material for use.

Alternatively, the adhesive material is sheeted and, when the outermost sheet of the adhesive material is spent it is removed by simply tearing away the contaminated sheet to reveal a fresh, uncontaminated sheet of adhesive material.

A further known alternative is disclosed in WO2006133024, which employs a length of adhesive tape running between two spindles. The adhesive tape is continually applied to and then removed from the surface of cleaning roller in order to clean debris from it. Optionally, the adhesive tape is used to engage an intermediary sheeted tape roll which cleans the cleaning roller. Engagement of the adhesive tape with the intermediary sheeted tape roll transfers accumulated particles as well as a spent sheet from the sheeted tape roll in order to renew the sheeted tape roll.

One of the drawbacks of the solutions according to the prior art is that the cleaning process has to be paused so that the user can remove and dispose of spent adhesive material or tape. Where adhesive material or tape is continually engaged with the contact cleaning roller, then any problems with the adhesive material or tape requiring correction and intervention by a user requires down time for the whole contact cleaning system in order to resolve. In addition, in such systems, the adhesive tape needs to be replaced by a user which necessitates downtime of the system.

Additionally, systems which use tape to remove particles and sheets from the surface of an intermediary sheeted roll are only ever in contact with a small proportion of the surface of the sheeted roll and so may be unreliable when removing the spent sheet.

Accordingly, it is an object of the invention to provide an apparatus which reduces or eliminates unnecessary down time in a contact cleaning apparatus. Certain embodiments provide an advantage that a contact cleaning apparatus may require minimal or no user intervention or involvement. In this way, a contact cleaning apparatus may be fully automated, in particularly when the outer surface of an adhesive roll requires restoring. A contact cleaning apparatus without user intervention also reduces the potential for human error, for example when elements of the apparatus are replaced or changed.

It is a further object of the invention to provide an apparatus in which a clean adhesive surface is quickly and simply restored. A yet further object is to provide apparatus which restores the performance of an adhesive roll surface, so that no residual debris remains on the surface.

### SUMMARY

In accordance with the present invention there is provided an apparatus for applying an adhesive layer to an adhesive roll according to the appended claims.

In accordance with the present invention there is provided a cartridge, including a housing and an applicator operably mounted in the housing, according to the appended claims.

In accordance with the present invention there is provided a cartridge, including a housing including both an applicator and an adhesive roll mounted to the housing, according to the appended claims.

In accordance with the present invention there is provided an apparatus for contact cleaning a substrate surface, including a contact cleaning roller, an adhesive roll and an applicator or cartridge, according to the appended claims.

According to a first aspect of the invention there is provided an apparatus for applying an adhesive layer to an adhesive roll in a contact cleaning device, said apparatus including an applicator arranged and configured to apply at least one adhesive layer to an outer surface of the adhesive roll.

In certain embodiments, said applicator applies said at least one adhesive layer as a film of adhesive material.

In certain embodiments, said outer surface has a circumference and said applicator is configured to apply a length of said adhesive layer sufficient to circumferentially cover at least a portion of the circumference. In this way, should the effectiveness in collecting debris of an adhesive roll fall below a required threshold, the outer surface may be restored. As the restoration is an additive process, the restoration is achieved without having the operator manually remove any adhesive layers or sheets.

In certain embodiments, said applicator is configured to apply a length of said adhesive layer sufficient to circumferentially cover substantially one circumference. In certain embodiments, said outer surface has an axial length and said applicator is configured to apply said adhesive layer sufficient to circumferentially cover at least a portion of the axial length. In certain embodiments, said applicator is configured to apply said adhesive layer sufficient to circumferentially cover substantially the axial length.

In certain embodiments, said applicator is configured to apply a length of said adhesive layer sufficient to circumferentially cover the outer surface in a single adhesive layer. In this way, the entire outer surface is restored by efficiently applying an adhesive layer.

In certain embodiments, said applicator is configured and arranged to transfer the at least one adhesive layer to the adhesive roll.

In certain embodiments, said applicator includes a roll of adhesive layer, releasably supported on a release surface, wherein said roll is wound around a core. In certain embodiments, said roll includes a continuous layer of adhesive layer releasably supported on a release surface. In certain embodiments, said release surface is formed of a substrate including paper or film. Even more preferably, said release surface includes a release agent. In certain embodiments, said release agent includes a silicone or a polyethylene coating.

Thus, the adhesive layer is provided in a convenient form which can be easily installed in a contact cleaning apparatus. In addition, the release surface and/or the adhesive layer may be adapted to ensure compatibility of the adhesive layer for a wide range of contact cleaning apparatuses, including varying types of adhesive rolls, outer surfaces and debris.

Furthermore, the propensity for adhesive layer to detach from the release surface and adhere to the outer surface may be adapted and controlled. In other words, in a contact cleaning system comprising the applicator according to the first aspect of the invention, the adhesive layer may be provided with a differential adhesion force between it and the release surface, and between it and the outer surface.

As the outermost adhesive layer on an outer surface collects debris, the outer surface is changed by the collected debris such that the debris-collecting effectiveness of the outer surface will thereby be reduced over time. The effectiveness will be reduced by increasing amounts of collected debris until the outer surface needs to be restored. The change of effectiveness also reflects a change in the differential adhesive force.

In certain embodiments, said adhesive layer includes a pressure sensitive adhesive.

According to a further aspect, there is provided a cartridge, including
a housing and an applicator operably mounted in the housing,
wherein said applicator is arrangeable and configurable to apply at least one adhesive layer to an outer surface of an adhesive roll in a contact cleaning device.

In this way, the applicator may be easily replaced when its store of adhesive layer is expended.

In certain embodiments, said cartridge further includes an adhesive roll operably mounted in the housing, wherein said adhesive roll is mounted adjacent said applicator such that said applicator is operable to selectively apply said at least one adhesive layer to an outer surface of said adhesive roll.

In certain embodiments, said adhesive roll provided as a core with an outer surface, wherein said outer surface includes an adhesive layer. Optionally, the adhesive roll may be provided without the adhesive layer.

In certain embodiments, the housing includes an opening through which a portion of the adhesive roll projects.

According to a further aspect, there is provided apparatus for contact cleaning a substrate surface, including
a cartridge including a housing with an adhesive roll and an applicator both operably mounted therein,
wherein said applicator is arranged and configured to apply at least one adhesive layer to an outer surface of said adhesive roll,
and a contact cleaning roller operably engageable with said adhesive roll.

In this way, the apparatus may be adapted so that the cartridge, including adhesive roll and applicator may easily be replaced when either its store of adhesive layer is expended, or when the adhesive roll has been applied with a threshold number of adhesive layers. The threshold number of adhesive layers may be determined by the dimensions of the apparatus or the cartridge. Alternatively, the quantity of the adhesive roll provided with the cartridge may be adapted to match the capacity of the associated adhesive roll to receive a threshold number of adhesive layers.

According to a further aspect, there is provided apparatus for contact cleaning a substrate surface, including
a contact cleaning roller adapted to collect debris from the substrate surface;
an adhesive roll, operably engageable with said contact cleaning roller; and an applicator, or a cartridge including a housing with an applicator operably mounted therein,
wherein said applicator or said cartridge is adapted such that said applicator selectively applies said at least one adhesive layer to an outer surface of said adhesive roll.

In this way, an apparatus can be provided in which the outer surface is easily restored. In other words, as the debris-collecting effectiveness of the outer surface of the adhesive roll falls to a threshold then the outer surface may be restored by the selective application of an adhesive layer from the applicator. Thus, the apparatus can operate continuously without downtime, other than for a brief restoration operation each time the effectiveness falls below the threshold.

In certain embodiments, the adhesive roll moves from a first position, operably engageable with a contact cleaning roller, to a second position, operably engageable with said adhesive layer. In this way, the adhesive roll may be restored quickly by simple engagement with the adhesive layer so that the spent outer surface is covered. Covering the spent outer layer with adhesive layer also covers any debris collected on the outer surface.

In certain embodiments, the adhesive roll moves from said first position to said second position when the cleaning effectiveness of the outer surface falls below a threshold. The threshold may be determined or measured by a detector or sensor, for example an optical detector. In this way, the restoration of the outer surface may be initiated automatically without user intervention. The contact cleaning apparatus may thus be automated to operate through many cleaning and restoration cycles.

In certain embodiments, the apparatus further includes a member configured and arranged to urge said adhesive layer onto the outer surface of the adhesive roll. In certain embodiments, said member is a backing roller. Thus, the apparatus can actively apply the adhesive layer, for example to overcome a lack of adhesive grab between the adhesive layer and the outer surface of the adhesive roll.

### BRIEF DESCRIPTION OF THE DRAWINGS

Embodiments of the invention are now described, by way of example only, hereinafter with reference to the accompanying drawings, in which:

FIG. 1 shows a perspective view of a first example embodiment of an applicator of a first aspect of the invention;

FIG. 2 shows a side view of a second example embodiment of a first aspect of the invention;

FIG. 3 shows a side view of a third example embodiment of a first aspect of the invention;

FIG. 4 shows a side view of a fourth example embodiment of an applicator mounted in a housing shown in a second position, of a first aspect of the invention; and

FIG. 5 shows a side view of a fifth example embodiment of an applicator and adhesive roll mounted in a housing, shown (a) in a first position and (b) a second position, of a first aspect of the invention.

In the drawings, like reference numerals refer to like parts.

### DETAILED DESCRIPTION

Certain terminology is used in the following description for convenience only and is not limiting. The words ‘upper’, ‘upward’, ‘down’ and ‘downward’ designate directions in the drawings to which reference is made and are with respect to the described component when assembled and mounted, the particular meaning being readily apparent from the context of the description.

Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

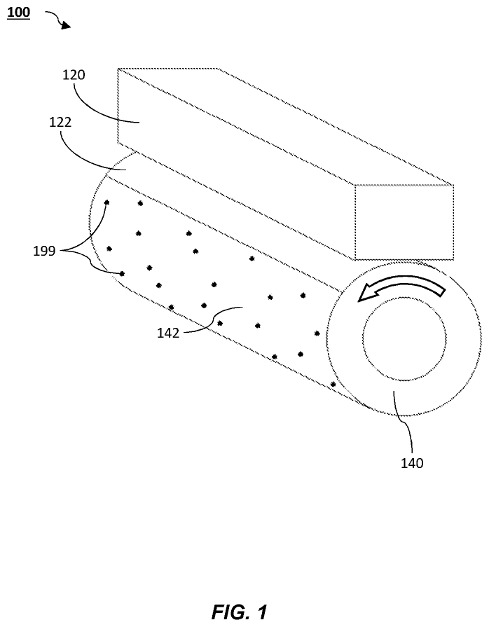

Referring now to FIG. 1, there is shown a general apparatus 100 according to a first aspect of the invention. The apparatus 100 includes an applicator 120 configured to apply an adhesive layer 122. The applicator 120 is positioned above an adhesive roll 140, as found in contact cleaning apparatus for collecting debris 199 from a contact cleaning roller, so that the adhesive layer 122 is applied onto the outer surface 142 of the adhesive roll 140. The applicator 120 applies the adhesive layer 122 as the adhesive roll 140 rotates so that the adhesive layer 122 covers the outer surface 142 and any debris 199 held thereon.

The applicator 120 is positioned to extend parallel to the axial direction of the adhesive roll 140. The adhesive roll 140 is mounted to rotate within a contact cleaning system as known in the art, so that its outer surface 142 engages with a contact cleaning roller (not shown) in order to collect debris. Debris 199 is collected until the effectiveness of the outer surface 142 falls below a required threshold. Although positioned above the adhesive roll 140, the applicator 120 remains disengaged from it while the debris collecting effectiveness of the outer surface 142 remains above the threshold.

When the debris collecting performance of the outer surface 142 falls below the required threshold the outer surface 142 is spent and must be restored. To restore the surface, the adhesive roll 140 disengages from the contact cleaning roller but continues to rotate. The adhesive roll 140 then operably engages with the applicator 120 so that the applicator 120 applies an adhesive layer 122 to the outer surface 142 as it passes underneath. The adhesive layer 122 thereby covers both the outer surface 142 and the previously collected debris 199.

The newly-applied adhesive layer 122 thus forms a restored outer surface 142 to the adhesive roll 140, suitable for collecting debris when the adhesive roll 140 is reengaged with the contact cleaning roller. Cleaning of the contact cleaning roller is thus able to can recommence with minimal downtime.

The restored outer surface 142 resumes collecting debris. Collection continues until its effectiveness again falls below a required threshold at which point the outer surface 142 may be restored again by applying a further adhesive layer as described above.

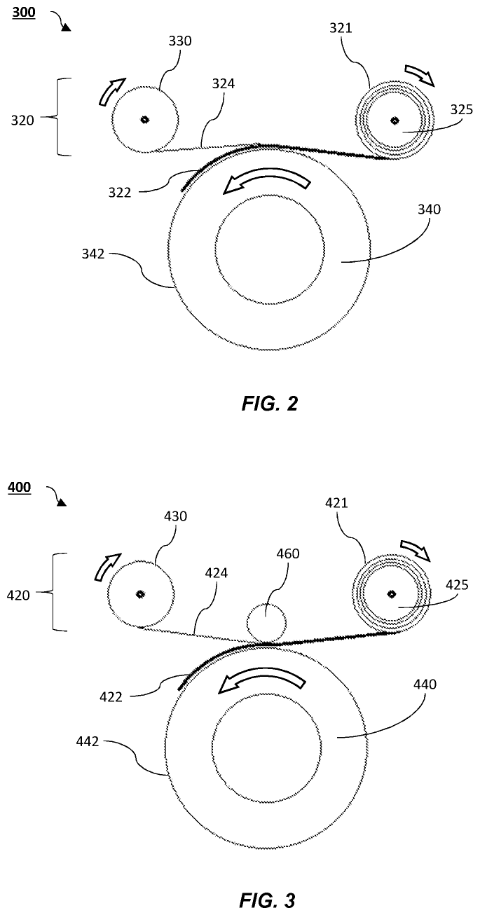

FIG. 2 shows a second embodiment of apparatus 300. Where the features are the same as previous embodiments, the reference numbers are the same other than the initial digit is a “3”. The embodiment shown in FIG. 2 includes an applicator 320 positioned above an adhesive roll 340 suitable to engage with and collect debris from a contact cleaning roller.

The applicator 320 includes a dispensing roll 321 and a receiving roll 330 arranged with mutually parallel axes. The dispensing roll 321 and receiving roll 330 each extend substantially the length of the adhesive roll 340 and are positioned, one slightly to either side, above the adhesive roll 340. The respective axes of the dispensing roll 321 and receiving roll 330 are thus arranged parallel to the adhesive roll 340 axis.

The dispensing roll 321 includes core 325 with a roll of adhesive layer 322 wound on to the core 325. The adhesive layer 322 is supported on a release surface 324. The release surface 324 extends from the dispensing roll 321 to the receiving roll 330 and is arranged such that rotation of the receiving roll 330 pulls and unwinds the release surface 324 from the dispensing roll 321, thereby winding it onto the receiving roll 330.

When wound around the dispensing roll 321, the inner surface of a portion of the adhesive layer 322 contacts a portion of the outer surface of the supporting release surface, while the outer surface of the portion contacts the inner surface of a portion of the release surface belonging to the layer outside it.

The adhesive roll 340 is mounted to the contact cleaning apparatus so that its axis moves between a first position and a second position. In the first position, not shown, the adhesive roll 240 is positioned to operably engages with a contact cleaning roller so that the outer surface 342 collects debris from the surface of the contact cleaning roller. The adhesive roll 340 is disengaged from the applicator 320 and not in contact with the adhesive layer 322.

In the second position, shown in FIG. 2, the adhesive roll 340 is positioned so that its outer surface 342 bears against the adhesive layer 322 supported on the release surface between the dispensing roll 321 and the receiving roll 330. The adhesive roll 340 is disengaged from the contact cleaning roller.

While in the first position, the outer surface 342 of the adhesive roll 340 collects debris from the contact cleaning roller. When the collecting effectiveness of the outer surface 342 reduces to a certain threshold, the outer surface 342 is spent and ready to be restored.

To restore the spent outer surface 342, the adhesive roll 340 selectively engages with the applicator 320 by moving from the first to the second position. The adhesive roll 340 continues to rotate in the same direction as when it was engaged with the contact cleaning apparatus. The dispensing roll 321 and receiving roll 330 are arranged to orient the release surface 324 so that the adhesive layer 322 bears against the adhesive roll 340 as it engages the applicator 320. The adhesive layer 322 bears against the adhesive roll 340 at a contact zone.

Within the contact zone, the leading edge of the adhesive layer 322 contacts and adhesively grabs the spent outer surface 342. As the adhesive roll 340 continues to rotate, the adhesive layer 322 is applied to the spent outer surface 342, covering the debris collected thereon.

Application of the adhesive layer 322 to the outer surface transfers the adhesive layer 322 from the release surface 324 to the adhesive roll 340. Rotation of the receiving roll 330 then winds the unloaded release surface 324 onto the receiving roll 330 so that it is removed from the contact zone.

Both the dispensing roll 321 and the receiving roll 330 extend the full axial length of the adhesive roll 340. Consequently, the adhesive layer 322 covers substantially the axial length of the adhesive roll 340 as it rotates. In this way, the applicator applies adhesive layer 322 to circumferentially cover the outer surface.

The adhesive layer 322 bears against adhesive roll 340 for the duration of a single rotation of the adhesive roll 340. Thus, the applicator 320 applies a length of adhesive layer 322 sufficient to circumferentially cover, or wrap, around the whole outer surface 342 and the debris collected thereon. A complete, restored outer surface is thus provided on the adhesive roll 340.

Operation of the contact cleaning apparatus thus recommences by movement of the adhesive roll 340 to its first position. As the adhesive roll 340 returns, it is separated from adhesive layer 322 remaining on the release surface 324 by breaking the adhesive layer 322. The return to the first position reengages the adhesive roll 340 with the contact cleaning roller until such a time that the adhesive roll 340 outer surface 342 is spent and needs restoring again.

FIG. 3 shows a third embodiment of apparatus 400. Where the features are the same as previous embodiments, the reference numbers are the same other than the initial digit is a “4”. The embodiment shown in FIG. 3 is substantially the same as the embodiment shown in FIG. 2, with the further inclusion of a backing roller 460 within the applicator 420.

The backing roller 460 is arranged above the adhesive roll 440 and extends substantially the whole length thereof. The backing roller 460 is positioned so that as the adhesive roll 440 moves to its second position and engages the applicator 420, then the adhesive layer 422 and release surface 424 are compressed between the outer surface 442 of the adhesive roll 440 and the backing roller 460.

The axis of the backing roller 460 is biased towards the outer surface 442 so that the backing roller 460 applies pressure to the contact zone. Consequently, as the adhesive layer 422 is applied to the outer surface 442, the backing roller 460 urges the adhesive layer 422 onto the outer surface 442. The additional urging force provided by the backing roller 460 aids transfer of the adhesive layer 422 from the release surface 424 to the outer surface 442.

The embodiments of FIGS. 2 and 3 describe the respective adhesive rolls as moving between first and second positions. It should be noted however, that the first and second positions refer to relative positions of the adhesive rolls and their respective applicators. Hence, while the embodiments are described with the adhesive rolls moving with respect to the applicator, the embodiments equally encompass alternative arrangements where the applicator moves with respect to the adhesive roll. In this way, the respective first positions are arrangements wherein the applicator is spaced apart and disengaged from the adhesive roll. The respective second positions are arrangements wherein the applicator has moved towards and engaged the adhesive roll so that the respective adhesive layer can bear on the respective outer surface.

In the alternative arrangements, as the applicator is moved into engagement with the adhesive roll, the adhesive roll may either simultaneously disengage from the contact cleaning roller, or remain in engagement. Where the adhesive roll remains in engagement it may contain to collect debris for the duration of the time that an adhesive layer is applied to its outer surface.

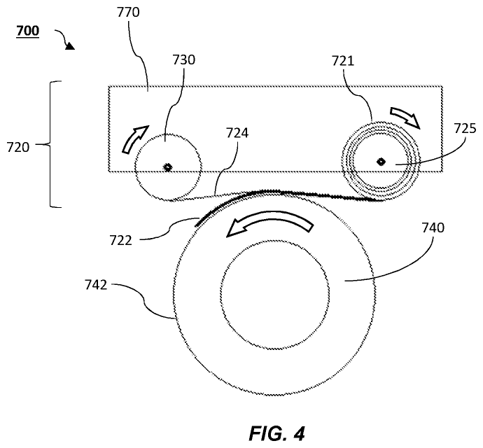

FIG. 4 shows a fourth embodiment of apparatus 700. Where the features are the same as previous embodiments, the reference numbers are the same other than the initial digit is a “7”. The embodiment shown in FIG. 4 is similar to the embodiment shown in FIG. 2, such that the applicator 720 includes a dispensing roll 721 with adhesive layer 722 wound onto a core 725, supported on a release surface 724. The release surface 724 extends from the dispensing roll 721 to a receiving roll 730 and is arranged such that rotation of the receiving roll 730 pulls and unwinds the release surface 724 from the dispensing roll 721, thereby winding it onto the receiving roll 730.

The dispensing roll 721 and receiving roll 730 are mounted to the housing of a cartridge 770. The cartridge 770 is mounted in a contact cleaning apparatus so that the dispensing roll 721 and receiving roll 721 are positioned above an adhesive roll 740 suitable to engage with and collect debris from a contact cleaning roller.

The dispensing roll 721 and receiving roll 730 are positioned above and oriented to extend axially in a direction parallel to the axial direction of the adhesive roll 740. The cartridge 770, and thereby both the dispensing roll 721 and receiving roll 730 extend across the full width of the adhesive roll 740.

The adhesive roll 740 is adapted to move between a first position and a second position in common with previously described embodiments. In the first position, not shown, the adhesive roll 740 is positioned to operably engage with a contact cleaning roller so that its outer surface 742 collects debris therefrom. The adhesive roll 740 is disengaged from the applicator 720 and is therefore not in contact with the adhesive layer 722.

While in the first position, the outer surface 742 of the adhesive roller 740 collects debris from the contact cleaning roller until its collecting effectiveness reduces to a certain threshold. At this point, the outer surface 742 is spent and ready to be restored.

To restore the outer surface 742, the adhesive roll 740 moves to the second position, shown in FIG. 4. The cartridge 770, and consequently the dispensing roll 721 and receiving roll 721 are positioned to orient the release surface 724 so that the adhesive layer 722 support thereon faces the adhesive roll 740. Thus, as the adhesive roll 740 moves to its second position, engaging with the applicator 720, the adhesive layer 722 supported on the release surface 724 bears against the adhesive roll 740. In this way, the adhesive layer 722 bears against the outer surface 742 in a contact zone.

Within the contact zone, the leading edge of the adhesive layer 722 contacts and adhesively grabs the spent outer surface 742. As the adhesive roll 740 continues to rotate, the adhesive layer 722 is applied to the spent outer surface 742, covering the debris collected thereon.

Application of the adhesive layer 722 to the outer surface transfers the adhesive layer 722 from the release surface to the adhesive layer 722. The receiving roll 721 winds the unloaded release surface 724, free from adhesive layer 722, onto the receiving roll 721 so that it is removed from the contact zone.

Both the dispensing roll 721 and the receiving roll 721 extend the full axial length of the adhesive roll 740 so that the adhesive layer 722 bears against substantially the whole axial length portion of the outer surface 742 as it rotates. In this way, the applicator 720 applies adhesive layer 722 to circumferentially cover the outer surface 742.

The adhesive layer 722 bears against adhesive roll 740 for the duration of a single rotation of the adhesive roll 740. Thus, the applicator 720 applies a length of adhesive layer 722 sufficient to circumferentially cover, or wrap, around the whole outer surface 742 and the debris collected thereon. A complete, restored outer surface 742 is thus provided on the adhesive layer 722. Cleaning of the contact cleaning roller is able to recommence until such a time that the adhesive roll 740 outer surface is spent and needs restoring again.

When the store of the adhesive layer 722 in the applicator 720 is expended then a replacement supply of adhesive layer may be provided by simply exchanging the first cartridge 770 for a new one. A new dispensing roll is mounted into the cartridge so as to be operable as soon as the cartridge is installed into the contact cleaning apparatus. Accordingly, an expended applicator is easily replaced.

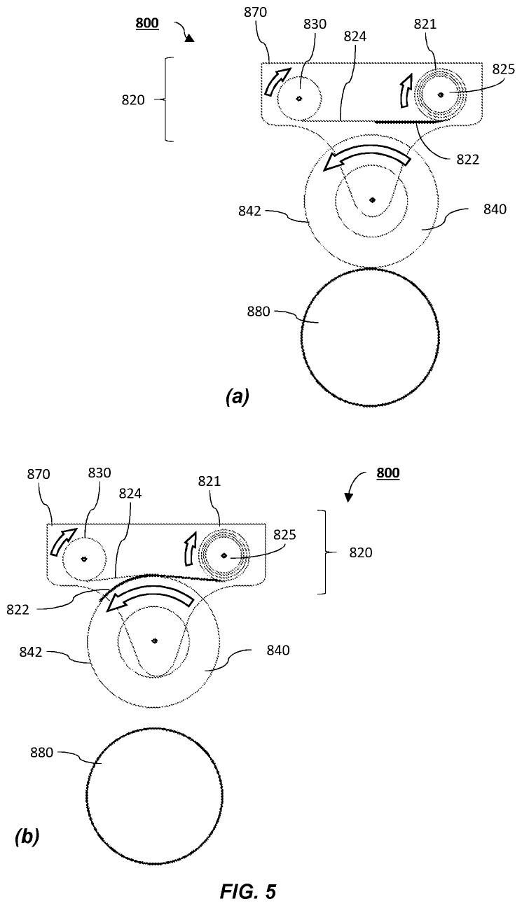

FIG. 5 shows a fifth embodiment of apparatus 800. Where the features are the same as previous embodiments, the reference numbers are the same other than the initial digit is a “8”. The embodiment shown in FIG. 7 is similar to the embodiment shown in FIG. 4, such that the applicator 820 includes a dispensing roll 821 and receiving roll 830 mounted to the housing of a cartridge 870. Additionally, an adhesive roll 840 is also mounted to the housing, adapted to selectively engage with the applicator 820. When the adhesive roll 840 selectively engages the applicator 820, the applicator 820 applies an adhesive layer 822 to its outer surface.

Similar to FIG. 4, the dispensing roll 821 includes an adhesive layer 822 supported on a release surface 824 which are wound onto a core 825 and, and a receiving roll. The dispensing roll 821 and receiving roll 830 are arranged such that rotation of the receiving roll 830 pulls and unwinds the release surface 824 from the dispensing roll 821, thereby winding it onto the receiving roll 830. The adhesive layer 822 is oriented on a release surface 824 such that the adhesive layer 822 faces the adhesive roll 840.

The adhesive roll 840 is mounted to the housing so that its axis moves between a first position and a second position. In the first position, as shown in FIG. 5a), the adhesive roll 840 is positioned to operably engage with a contact cleaning roller 880 so that the adhesive roll 840 outer surface 842 collect debris therefrom. The adhesive roll 840 is disengaged from the applicator 820 and is therefore not in contact with the adhesive layer 822.

In the second position, as shown in FIG. 5b), the adhesive roll 840 is positioned so that its outer surface 842 bears against the adhesive layer 822 provided on the release surface 824 extending between the dispensing roll 821 and receiving roll 830. The adhesive roll 840 is disengaged from the contact cleaning roller 880.

With the cartridge 870 mounted in a contact cleaning apparatus the adhesive roll 840 is provided in the cartridge 870 in its first position so that the outer surface 842 collects debris from the contact cleaning roller 880. The first position is maintained so long as the collecting effectiveness of the outer surface 842 remains above a threshold.

When the collecting effectiveness falls below the threshold, the outer surface 842 is spent and requires restoring. Consequently, the adhesive roll 840 is moved to its second position. The applicator 820 thus engages with the adhesive roll 840 and so that the adhesive layer 822 may be applied to its outer surface 842.

With rotation of the adhesive roll 840 the applicator 820 provides a length of adhesive layer 822 sufficient to circumferentially cover the spent outer surface 842. The adhesive layer 822 also covers the debris collected on the spent surface to form a new outer surface 842.

In a similar fashion to the example of FIG. 4, the cartridge 800 is easily removable from the contact cleaning apparatus. Thus, the replacement of the expended adhesive layer 822 as well as the adhesive roll 840 is can be quickly and easily achieved.

The change of position of the adhesive rolls in the embodiments of FIGS. 4 and 5 from their respective first position to their respective second position is provided by relative movement of the adhesive roll axis within the cartridge.

As shown in FIGS. 5 a) and b), one way of achieving this is for the housing to remain stationary while the adhesive roll 840 disengages and moves away from the contact cleaning roller. In this way, the relative movement is provided by movement of the adhesive roll 840 towards and away from the applicator 820. This movement may be replicated in the embodiment of FIG. 4.

In embodiments not shown, the change of position may alternatively be achieved while the respective adhesive rolls remain engaged with the respective contact cleaning rollers. In these alternatives, the adhesive roll axis remains in a constant position while the cartridge, including the housing and applicator, moves towards the contact cleaning roller. In this way, the relative movement is provided by movement of the applicator towards and away from the adhesive roll. The outer surface thus bears against the adhesive layer due to the movement of the applicator towards the adhesive roll.

In the second position, the adhesive layer circumferentially covers the spent outer surface and the collected debris in the same way as described above. With a new outer surface formed, the adhesive roll is restored, and the applicator can return to the first position. Thus, the alternative change of position allows the outer surface to be restored while maintaining uninterrupted collection of debris from the contact cleaning roller.

Further configurations of the examples described above, along with other examples and alternatives within the scope of the invention will be apparent to the skilled person.

Although examples comprising single adhesive rolls engaging individual contact cleaning rollers are described herein, the apparatus of the invention may be readily configured for apparatus with other configurations, for example, comprising multiple, adhesive rolls and/or multiple contact cleaning rollers.

In the certain examples, the adhesive roll disengages with the contact cleaning roller before engaging with the applicator so that the applicator can apply an adhesive layer. However, depending on the nature of the adhesive layer, the adhesive roll may not require disengaging with the contact cleaning roller. Thus, when the outer surface is spent, the applicator may simply be engaged with the adhesive roll and apply the adhesive layer. In this case, so long as the adhesive layer is applied in a form readily usable to collect debris then operably engagement of the adhesive layer with the contact cleaning roller may be uninterrupted as the outer surface is restored.

In certain examples, a backing roller is used. Other alternatives members may be used to urge the adhesive layer onto the outer surface. For example, a bar, a doctor blade or a tension roller. Optionally, the adhesive roll itself may be biased to press the adhesive layer against the bar, tension roller or blade.

In certain examples, the applicator is described as providing cover to a portion of the outer surface. It will be apparent to the skilled person that any of the examples described herein could also be adapted to provide cover to a portion of their respective outer surfaces in a similar manner.

Although the adhesive layer in the disclosed embodiment are described as restoring the outer surface by applying a single layer, multiple layers may be applied if particularly necessary.

1-21. (canceled)

22. An apparatus for applying an adhesive layer to an adhesive roll in a contact cleaning device, the apparatus comprising an applicator arranged and configured to apply at least one adhesive layer to an outer surface of the adhesive roll.

23. The apparatus according to claim 22, wherein the applicator applies the at least one adhesive layer as a film of adhesive material.

24. The apparatus according to claim 22, wherein the outer surface has a circumference and the applicator is configured to apply a length of the adhesive layer sufficient to circumferentially cover at least a portion of the circumference.

25. The apparatus according to claim 24, wherein the applicator is configured to apply a length of the adhesive sufficient to circumferentially cover substantially one circumference.

26. The apparatus according to claim 24, wherein the outer surface has an axial length and the applicator is configured to apply the adhesive layer sufficient to circumferentially cover at least a portion of the axial length.

27. The apparatus according to claim 26, wherein the applicator is configured to apply the adhesive layer sufficient to circumferentially cover substantially the axial length.

28. The apparatus according to claim 22, wherein the applicator is configured to apply a length of the adhesive layer sufficient to circumferentially cover the outer surface in a single adhesive layer.

29. The apparatus according to claim 22, wherein the applicator is configured and arranged to transfer the at least one adhesive layer to the adhesive roll.

30. The apparatus according to claim 22, wherein the applicator comprises a roll of adhesive layer, releasably supported on a release surface, wherein the roll is wound around a core.

31. The apparatus according to claim 30, wherein the roll comprises a continuous layer of adhesive layer releasably supported on a release surface.

32. The apparatus according to claim 31, wherein the release surface is formed of a substrate comprising paper or film.

33. The apparatus according to claim 32, wherein the release surface comprises a release agent.

34. The apparatus according to claim 33, wherein the release agent comprises a silicone or a polyethylene coating.

35. The apparatus according to claim 22, wherein the adhesive layer comprises a pressure sensitive adhesive.

36. A cartridge comprising a housing and the applicator according to claim 22 operably mounted in the housing.

37. The cartridge according to claim 36, further comprising an adhesive roll operably mounted in the housing, wherein the adhesive roll is mounted adjacent the applicator such that the applicator is operable to selectively apply the at least one adhesive layer to an outer surface of the adhesive roll.

38. The cartridge according to claim 37, wherein the housing comprises an opening through which a portion of the adhesive roll projects.

39. An apparatus for contact cleaning of a substrate surface, comprising the cartridge of claim 36 and a contact cleaning roller operably engageable with the adhesive roll.

40. An apparatus for contact cleaning of a substrate surface, comprising:
a contact cleaning roller adapted to collect debris from the substrate surface;
an adhesive roll, operably engageable with the contact cleaning roller;
and the applicator according to claim 22, wherein the applicator is adapted such that the applicator selectively applies the at least one adhesive layer to an outer surface of the adhesive roll.

41. The apparatus according to claim 22, further comprising a member configured and arranged to urge the adhesive layer onto the outer surface of the adhesive roll.
